(19) United States
(12) Patent Application Publication
(10) Pub. No.: US 2026/0153066 A1
(43) Pub. Date: Jun. 4, 2026

(54) GASEOUS FUEL INJECTION VALVE

(71) Applicant: DENSO CORPORATION, Kariya-city (JP)

(72) Inventor: Takashi FURUKAWA, Kariya-city (JP)

(21) Appl. No.: 19/465,714

(22) Filed: Jan. 30, 2026

Related U.S. Application Data
(63) Continuation of application No. PCT/JP2024/025626, filed on Jul. 17, 2024.

(30) Foreign Application Priority Data
Aug. 3, 2023 (JP) 2023-127077

(51) Int. Cl. F02M 21/02

(52) U.S. Cl. CPC F02M 21/026; F02M 21/0275

(57) ABSTRACT

A gaseous fuel injection valve directly injects fuel into an internal combustion engine's chamber. The valve features a cylindrical main body with an internal fuel passage divided by a partition into upstream and downstream sections, connected via a communication hole. The main body houses a first valve, a second valve, and a seal member. The first valve controls the communication hole from the upstream side, actuated by a drive unit, while the second valve operates from the downstream side, opening when chamber pressure exceeds a set bias. The seal member provides a seal around the communication hole opening. An extended portion of the main body downstream from the partition is cooled by gaseous fuel that impinges upon the expended portion after adiabatic expansion through the communication hole.

### CROSS REFERENCE TO RELATED APPLICATIONS

The present application is a continuation application of International Patent Application No. PCT/JP2024/025626 filed on Jul. 17, 2024, which designated the U.S. and claims the benefit of priority from Japanese Patent Application No. 2023-127077, filed on Aug. 3, 2023. The entire disclosures of all of the above applications are incorporated herein by reference.

### TECHNICAL FIELD

The present disclosure relates to a gaseous fuel injection valve.

### BACKGROUND

A gas metering valve is a gaseous fuel injection valve that may be used in direct injection gas engines. In the gas metering valve, an elastomeric seal member may be provided on an actuator-driven valve element to suppress leakage of gaseous fuel.

### SUMMARY

According to an aspect of the present disclosure, a gaseous fuel injection valve directly injects gaseous fuel into a combustion chamber of an internal combustion engine. The gaseous fuel injection valve includes a main body formed in a cylindrical shape. The main body includes a fuel passage and an injection hole. The fuel passage is located inside the main body, the injection hole is located at a tip end of the main body. The main body has a partition that divides the fuel passage into a first fuel passage and a second fuel passage. The first fuel passage is an upstream portion of the fuel passage. The second fuel passage is a downstream portion of the fuel passage. The partition has a communication hole through which the first fuel passage communicates with the second fuel passage. The main body includes a first valve, a second valve, and a seal member inside the main body. The first valve opens and closes the communication hole from a side of the first fuel passage, and the second valve opens and closes the communication hole from a side of the second fuel passage. A seal member is located between the first valve and the partition, and seals a region around an opening of the communication hole. The first valve is opened by a drive unit, and the second valve is opened in response to a pressure inside the communication hole exceeding a biasing force of a biasing member that urges the second valve toward a closed position. The main body may further include an extended portion that extends toward the downstream portion from the partition. The main body may include a structure that cools the extended portion by causing the gaseous fuel, which has flowed out from the communication hole and undergone adiabatic expansion upon opening of the second valve, to impinge on the extended portion.

### BRIEF DESCRIPTION OF DRAWINGS

Objects, features and advantages of the present disclosure will become more apparent from the following detailed description made with reference to the accompanying drawings. In the drawings:

FIG. 1 is a longitudinal sectional view of a fuel injection valve;

FIG. 2 is a perspective view of a second cylindrical portion;

FIG. 3 is an enlarged longitudinal sectional view showing a nozzle body and a lower valve;

FIG. 4 is a cross-sectional view taken along line 4-4 in FIG. 3;

FIG. 5 is a perspective view of the lower valve;

FIG. 6 is a longitudinal sectional view showing the fuel injection valve in an open state;

FIG. 7 is an enlarged longitudinal sectional view showing the nozzle body and the lower valve in another embodiment; and

FIG. 8 is a longitudinal sectional view showing the configuration of the fuel injection valve in another embodiment.

### DETAILED DESCRIPTION

In a gas metering valve in the related field, an elastomeric seal member may be provided on an actuator-driven valve element to suppress leakage of gaseous fuel. At the same time, in order to prevent damage to a seal member caused by heat and pressure generated during combustion in a gas engine, the sealing position of the valve element may be set significantly apart from a fuel outlet opening. Additionally, in the gas metering valve, a check valve (passive-type valve) that opens in response to the pressure difference between the upstream and downstream sides may be provided between the actuator-driven valve element and the outlet opening. This configuration serves to suppress the propagation of flames or combustion pressure from the combustion chamber to the seal member. As a result, the elastomeric seal member may be effectively protected.

However, the above gas metering valve may increase the separation between the valve element provided with the seal member and the downstream check valve, resulting in a larger volume between these valve elements and the check valve. Therefore, it is conceivable that the closing response of the check valve when the upstream valve element is closed is low due to the increased volume, and as a result of this decreased responsiveness, gas leakage may occur at the fuel injection valve, which in turn raises concerns about abnormal combustion in the gas engine. On the other hand, if the upstream valve element with a sealing function is installed closer to the check valve, the seal member of the valve element may be damaged by heat.

According to the present disclosure, a gaseous fuel injection valve directly injects gaseous fuel into a combustion chamber of an internal combustion engine. The gaseous fuel injection valve includes a main body formed in a cylindrical shape. The main body includes a fuel passage and an injection hole. The fuel passage is located inside the main body, the injection hole is located at a tip end of the main body. The main body has a partition that divides the fuel passage into a first fuel passage and a second fuel passage. The first fuel passage is an upstream portion of the fuel passage. The second fuel passage is a downstream portion of the fuel passage. The partition has a communication hole through which the first fuel passage communicates with the second fuel passage. The main body includes a first valve, a second valve, and a seal member inside the main body. The first valve opens and closes the communication hole from a side of the first fuel passage, and the second valve opens and closes the communication hole from a side of the second fuel passage. A seal member is located between the first valve and the partition, and seals a region around an opening of the communication hole. The first valve is opened by a drive unit, and the second valve is opened in response to a pressure inside the communication hole exceeding a biasing force of a biasing member that urges the second valve toward a closed position. The main body further includes an extended portion that extends toward the downstream portion from the partition. The main body includes a structure that cools the extended portion by causing the gaseous fuel, which has flowed out from the communication hole and undergone adiabatic expansion upon opening of the second valve, to impinge on the extended portion.

In the fuel injection valve having the above configuration, the upstream side of the partition in the cylindrical body portion serves as the first fuel passage, and the downstream side of the partition serves as the second fuel passage, with the first and second fuel passages being connected by the communication hole. Then, when the first valve is opened by the drive unit and the communication hole is opened from the first fuel passage side, the pressure inside the communication hole rises due to the opening of the first valve, causing the passive second valve to open and the communication hole to be opened also on the second fuel passage side. When the communication hole is opened on both the upstream and downstream sides, gaseous fuel is injected from the fuel injection valve. In this case, a seal member that seals around the opening of the communication hole is provided between the first valve and the partition, making it possible to enhance gas sealing performance compared to a configuration in which the first valve and the partition are in direct contact in the closed state of the first valve.

In addition, when gaseous fuel flows out from the communication hole as the second valve opens, adiabatic expansion of the gaseous fuel occurs, and the partition is cooled by the gaseous fuel whose temperature has decreased due to this adiabatic expansion. That is, as the second valve opens, the gaseous fuel that flows out from the communication hole and undergoes adiabatic expansion impinges on an extended portion extending downstream from the partition, thereby cooling the extended portion, and as the extended portion is cooled, the partition is further cooled. Then, as the partition is cooled, the seal member provided on the opposite side of the second valve (the side of the first valve) across the partition is also cooled. In this case, although the seal member is provided at a relatively close position separated from the second valve only by the partition, excessive temperature rise of the seal member is suppressed. Furthermore, because the upstream and downstream valves are arranged relatively close to the partition, with the partition positioned in between, any decrease in the responsiveness of the passive-type second valve can be suppressed. As a result, it is possible to protect the seal member while ensuring the injection performance of the gaseous fuel.

The following describes an embodiment that concretizes a gaseous fuel injection valve according to the present disclosure with reference to the drawings. The gaseous fuel injection valve according to the present embodiment is applied to a direct injection type gas engine (internal combustion engine) that uses either hydrogen, CNG (Compressed Natural Gas), or LNG (Liquefied Natural Gas) as a gaseous fuel. The gaseous fuel is directly injected into a combustion chamber of a gas engine by the gaseous fuel injection valve. The gas engine is, for example, an onboard engine for a vehicle. The fuel injection system according to the present embodiment is a so-called low-pressure direct injection system, in which gaseous fuel compressed to several MPa is injected from the fuel injection valve into the combustion chamber.

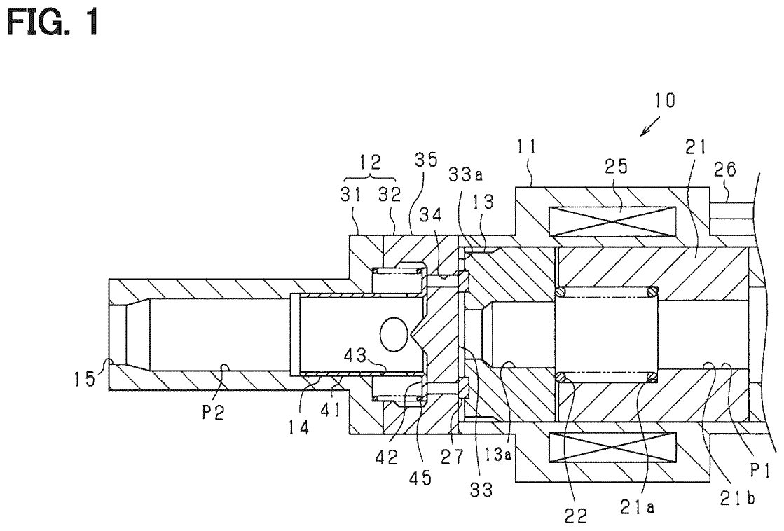

The structure of a fuel injection valve 10 will be explained with reference to FIG. 1. In the following description, the direction along the axis—which extends in the longitudinal direction and passes through the center of the cross-section of the fuel injection valve 10—is referred to as the axial direction. The direction extending radially from the axis is referred to as the radial direction, and the direction extending circumferentially around the axis is referred to as the circumferential direction. In FIG. 1, the right side is designated as the base end side (upstream side) of the fuel injection valve 10, and the left side is designated as the tip end side (downstream side).

The fuel injection valve 10, in outline, includes a housing 11, a nozzle body 12 located on the tip end side relative to the housing 11, an upper valve 13 provided reciprocally movable within the housing 11, and a lower valve 14 provided reciprocally movable within the nozzle body 12. The upper valve 13 is an active upstream valve that opens by electromagnetic actuation, while the lower valve 14 is a passive downstream valve that opens in response to the pressure difference between the upstream and downstream sides. In the fuel injection valve 10, the opening of the upper valve 13 causes the lower valve 14 to open, and when both of the valves 13 and 14 are open, the gaseous fuel is injected from the injection hole 15. It is noted that the housing 11 and the nozzle body 12 correspond to the “main body,” the upper valve 13 corresponds to the “first valve,” and the lower valve 14 corresponds to the “second valve.”

Although not illustrated as it is a well-known structure, the fuel injection valve 10 is assembled to the gas engine such that its tip end (the nozzle body 12) is exposed within the combustion chamber. The fuel injection valve 10 directly injects gaseous fuel into the combustion chamber. The following provides a detailed explanation of the construction of each part of the fuel injection valve 10.

The housing 11 is formed in a cylindrical shape, and within its hollow portion, a fixed core 21 is secured. Additionally, the upper valve 13 is accommodated at a position aligned with the fixed core 21 in the axial direction so as to be capable of reciprocating movement. The upper valve 13 includes a movable core. The fixed core 21 has a cylindrical shape, and a first spring 22, which is a compression coil spring, is disposed inside the fixed core 21. The first spring 22 is provided between a spring seat portion 21a of the fixed core 21 and the axial end surface of the upper valve 13. By means of the first spring 22, the upper valve 13 is biased toward the tip end side of the fuel injection valve 10 (that is, in a direction to close the communication hole 34 from the base end side, as will be described later).

The fixed core 21 has a hollow portion 21b, and the upper valve 13 has a hollow portion 13a. These hollow portions 21b and 13a extend in the axial direction and communicate with each other. When gaseous fuel is supplied from the fuel pipe provided on the base end side relative to the fixed core 21, the gaseous fuel is introduced to the tip end side of the upper valve 13 via an upstream fuel passage P1, which is formed by the hollow portions 21b and 13a of the fixed core 21 and the upper valve 13, respectively. In the present embodiment, for example, hydrogen gas is used as the gaseous fuel, and gaseous fuel compressed to approximately 3 MPa is introduced into the fuel passage P1.

Further, a coil 25 is provided in the housing 11 as a drive unit for the fuel injection valve 10. A conduction signal is provided to the coil 25 from a power supply device (not shown) via a harness 26. When the coil 25 is energized, magnetic energy is generated, and this magnetic energy causes the upper valve 13 to be displaced toward the open position against the biasing force of the first spring 22.

The nozzle body 12 is provided on the downstream side of the upper valve 13. The nozzle body 12 has a first cylinder 31 on the tip end side and a second cylinder 32 on the base end side, with the inner circumferential sides of these cylinders 31 and 32 forming a downstream fuel passage P2. At one end in the axial direction of the first cylinder 31, an injection hole 15 is formed. The second cylinder 32 has an end plate 33 provided at the base end of the second cylinder 32. The end plate 33 is formed with communication holes 34 extending in the axial direction. The end plate 33 serves as a partition that separates the upstream fuel passage P1, formed by the fixed core 21 and the upper valve 13, from the downstream fuel passage P2, formed by the nozzle body 12, in the fuel injection valve 10. The communication hole 34 is a communication passage that connects the upstream and downstream fuel passages P1 and P2. The end plate 33 serves as a pressure barrier to prevent the pressure generated by combustion in the engine combustion chamber from propagating to the upstream fuel passage P1.

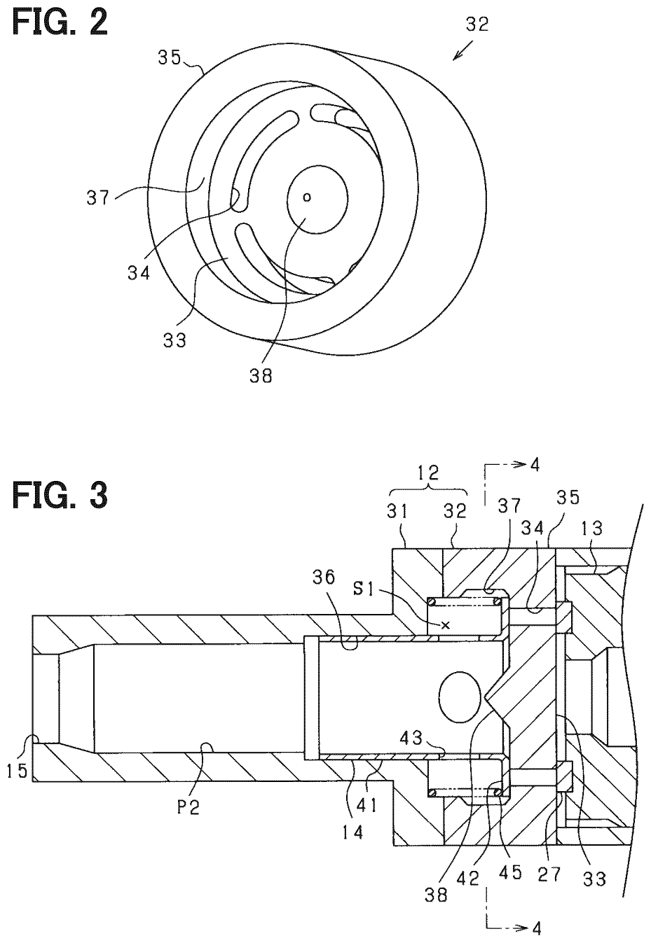

FIG. 2 is a perspective view of the second cylinder 32. As shown in FIG. 2, the second cylinder 32 is provided with a peripheral wall 35 extending downstream (to the left in the figure) from the outer peripheral portion of the end plate 33. In addition, the communication holes 34 are provided at the end plate 33 in a circumferential arrangement along the peripheral wall 35. Each communication hole 34 is formed in an arc shape extending in the circumferential direction. However, the opening shape of each communication hole 34 may be arbitrary, and, for example, may have a circular opening shape.

Returning to the description of FIG. 1, an annular plate-shaped seal member 27 is fixed to the axial end surface of the upper valve 13 at a position facing the opening of each communication hole 34. In the state where the upper valve 13 is closed by the biasing force of the first spring 22 (the state shown in FIG. 1), the seal member 27 comes into contact with the seat surface 33a, which is the axial end face of the end plate 33, and the first opening, which is the upstream opening of the communication hole 34, is closed by the seal member 27. Then, when the upper valve 13 is displaced to the open position, the seal member 27 separates from the seat surface 33a of the end plate 33, and the first opening is opened. The seal member 27 is formed of any elastic material having elasticity, such as a rubber material, resin material, or elastomer material, and more specifically, a fluororubber or EPDM (ethylene propylene diene rubber) is preferably used as the sealing material.

Within the nozzle body 12, the lower valve 14 is provided for opening and closing the communication hole 34 from the fuel passage P2 side. The lower valve 14 includes a cylindrical portion 41 and a flange-shaped opening/closing portion 42 extending in the radial direction, which is provided at one axial end of the cylindrical portion 41. The cylindrical portion 41 is a sliding portion that can slide axially along the inner peripheral surface of the first cylinder 31, and the opening/closing portion 42 is a closure plate that closes the second opening, which is the downstream-side opening of the communication hole 34. The opening/closing portion 42 is capable of being lifted between a closed position, in which it blocks the second opening (downstream opening) of the communication hole 34, and an open position, in which the second opening is opened. In the present embodiment, the opening/closing portion 42 has an annular plate shape and is provided so as to extend radially outward from the cylindrical portion 41.

A second spring 45, which is a compression coil spring, is disposed between the opening/closing portion 42 and the axial end surface of the first cylinder 31. By means of the second spring 45, the lower valve 14 is biased toward the base end side of the fuel injection valve 10 (that is, in a direction that closes the communication hole 34 from the tip end side). The lower valve 14 is opened when the pressure inside the communication hole 34 becomes greater than the biasing force of the second spring 45. The second spring 45 corresponds to a “biasing member.”

The lower valve 14 may be formed of a metal material, a non-metal material, or another non-elastomer material having excellent heat resistance. By pressing the opening/closing portion 42 against the downstream-side opening of the communication hole 34, leakage of the gaseous fuel from the communication hole 34 is suppressed, and, at the same time, the inflow of flames or combustion pressure from the combustion chamber is also suppressed.

In the end plate 33, the communication hole 34 is closed by the upper valve 13 from the fuel passage P1 side, which is one side in the axial direction, and is also closed by the lower valve 14 from the fuel passage P2 side, which is the other side in the axial direction. The upper valve 13 is an inward-opening valve that opens toward the base end side of the fuel injection valve 10, while the lower valve 14 is an outward-opening valve that opens toward the tip end side of the fuel injection valve 10.

In the fuel injection valve 10, when the upper valve 13 is displaced to the open position as the coil 25 is energized, the gaseous fuel in the upstream fuel passage P1 flows into the communication hole 34, causing the pressure inside the communication hole 34 to increase. Then, when the pressure inside the communication hole 34 exceeds the biasing force of the second spring 45, the lower valve 14 is displaced to the open position. In this case, when both the upper and lower valves 13 and 14 on either side of the communication hole 34 are in the open state, gaseous fuel flows from the upstream fuel passage P1 to the downstream fuel passage P2, and further, the gaseous fuel is injected from the injection hole 15 at the tip of the fuel passage P2.

In the fuel injection valve 10 according to the present embodiment, during a period between the closing and subsequent opening of the upper valve 13, gaseous fuel remains in the communication hole 34 provided at the end plate 33. In this case, the total volume of the communication holes 34 provided in the end plate 33 is equal to the residual gas volume remaining on the downstream side of the upper valve 13 during the period between the closing and the subsequent opening of the upper valve 13.

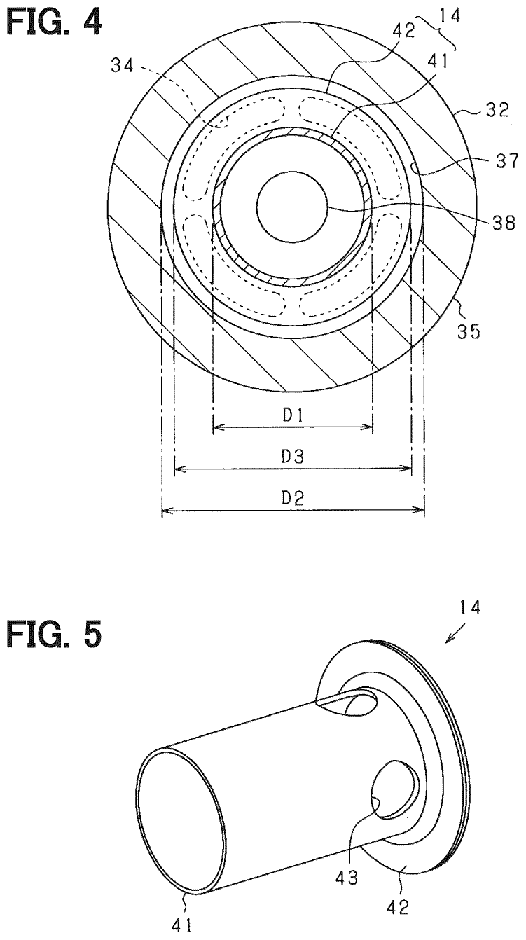

The following describes the configuration related the outflow of gaseous fuel from the communication hole 34 accompanying the opening of the lower valve 14 in detail. FIG. 3 is an enlarged longitudinal sectional view showing the nozzle body 12 and the lower valve 14, and FIG. 4 is a cross-sectional view taken along line 4-4 in FIG. 3. In FIG. 4, the communication hole 34 of the end plate 33 is indicated by a dashed line. FIG. 5 is a perspective view of the lower valve 14.

As shown in FIG. 3, in the nozzle body 12, a sliding surface 36 for allowing the cylindrical portion 41 of the lower valve 14 to slide is formed on the inner peripheral portion of the first cylinder 31. In addition, an enlarged inner peripheral surface 37, having a larger diameter than the sliding surface 36, is formed on the inner peripheral portions of the first cylinder 31 and the second cylinder 32. As a result, the inner peripheral side of the peripheral wall 35 forms an expanded space S1 that is expanded radially outward in the most upstream portion (i.e., a predetermined range on the most upstream side) of the fuel passage P2. That is, in the nozzle body 12, the passage diameter of the fuel passage P2 differs between the most upstream portion and the downstream side thereof, and an annular expanded space S1 is formed by enlarging the passage diameter at the most upstream portion. In relation to the lower valve 14, the expanded space S1 is formed on the radially outer side of the cylindrical portion 41.

The second spring 45 is housed within the expanded space S1. It is noted that the enlarged inner peripheral surface 37 and the expanded space S1 formed by the enlarged inner peripheral surface 37 may be formed by both the first cylinder 31 and the second cylinder 32, or may be formed solely by the second cylinder 32, as long as they are located downstream of the end plate 33 in the nozzle body 12.

Further, a protrusion 38 that protrudes downstream is provided at a central position of the downstream end surface of the end plate 33. The protrusion 38 is provided on the radially inner side of the peripheral wall 35, and more specifically, the protrusion 38 is provided on the radially inner side of the cylindrical portion 41 of the lower valve 14, which is located on the radially inner side of the peripheral wall 35. The protrusion 38 is formed in a conical shape. However, the shape of the protrusion 38 is not limited to this and may be cylindrical, prismatic, pyramidal, or any other shape, and multiple protrusions 38 may also be provided. It is noted that the peripheral wall 35 and the protrusion 38 correspond to the “extended portion.”

Here, as shown in FIG. 4, if the outer diameter of the cylindrical portion 41 of the lower valve 14 (in other words, the inner diameter of the sliding surface 36 of the first cylinder 31) is defined as D1, the inner diameter of the enlarged inner peripheral surface 37 is defined as D2, and the outer diameter of the opening/closing portion 42 of the lower valve 14 is defined as D3, then these dimensions have the relationship D1<D3, and D2>D3. That is, the expanded space S1 is formed by enlarging the inner diameter D2 of the enlarged inner peripheral surface 37 relative to the outer diameter D1 of the cylindrical portion 41 (the inner diameter of the sliding surface 36). Further, since the inner diameter D2 of the enlarged inner peripheral surface 37 is greater than the outer diameter D3 of the opening/closing portion 42, it is possible to form a radial gap between the enlarged inner peripheral surface 37 and the outer periphery of the opening/closing portion 42.

Therefore, when the lower valve 14 is displaced to the open position, the gaseous fuel flowing out downstream from the communication hole 34 flows along both the radially outer side and the radially inner side of the gap between the downstream end face of the end plate 33 and the opening/closing portion 42. That is, the opening/closing portion 42 has a portion protruding radially outward from the opening of the communication hole 34 and a portion protruding radially inward, and these protruding portions guide the gaseous fuel flowing out from the communication hole 34 in both the radially outward and radially inward directions, respectively. The opening/closing portion 42 corresponds to a “guide portion.” At this time, the gaseous fuel flowing in the radially outward direction advances so as to collide with the enlarged inner peripheral surface 37 (the inner peripheral surface of the peripheral wall 35), and is introduced into the expanded space S1 through the gap between the enlarged inner peripheral surface 37 and the outer peripheral portion of the opening/closing portion 42. In addition, the gaseous fuel flowing in the radially inward direction advances so as to collide with the protrusion 38 of the end plate 33.

Additionally, multiple openings 43 are provided at predetermined intervals in the circumferential direction on the cylindrical portion 41 of the lower valve 14 (see FIG. 5). Therefore, through the opening 43, the inside and outside of the cylindrical portion 41—that is, the expanded space S1 and the inner space located radially inward thereof—are configured to be in communication with each other.

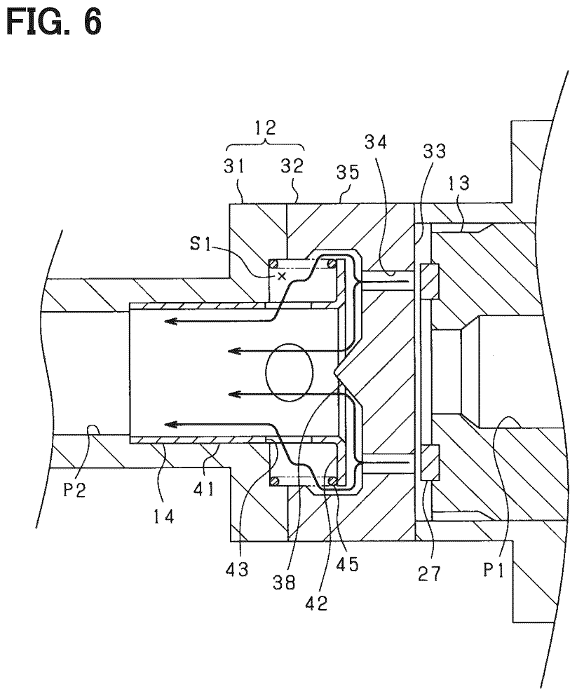

FIG. 6 is a diagram for explaining the flow of gaseous fuel when the fuel injection valve 10 is in an open state. In FIG. 6, both the upper valve 13 and the lower valve 14 of the fuel injection valve 10 are in the open state, and the flow of the gaseous fuel is indicated by arrows.

When the opening/closing portion 42 moves away from the downstream end surface (downstream seat surface) of the end plate 33 as the lower valve 14 opens, the gaseous fuel flows out from the communication hole 34, and at this time, the temperature of the gaseous fuel decreases due to adiabatic expansion. Specifically, in a gas engine, gaseous fuel is injected from the fuel injection valve 10 during at least one of the intake stroke and the compression stroke. At the time of fuel injection, as the lower valve 14 opens and the gaseous fuel flows out from the communication hole 34, the pressure of the gaseous fuel is reduced from several MPa to approximately atmospheric pressure. For example, when the gas supply pressure is 2 MPa or higher, it is considered that the gas temperature decreases by 100° C. or more due to adiabatic expansion.

The gaseous fuel that has flowed out from the communication hole 34 impinges on the flange-shaped opening/closing portion 42 and then flows downward, being divided into a radially outer side and a radially inner side. That is, the gaseous fuel flowing out from the communication hole 34 is guided by the opening/closing portion 42 of the lower valve 14 toward both the radially outer side and the radially inner side, respectively. The gaseous fuel guided to the radially outer side impinges on the inner circumferential surface of the peripheral wall 35, and then flows downstream through the expanded space S1 and the opening 43 of the lower valve 14 into the fuel passage P2. At this time, as the gaseous fuel, which has experienced a temperature drop due to adiabatic expansion when flowing out from the communication hole 34, is introduced into the expanded space S1, heat exchange within the expanded space S1 is enhanced. As a result, cooling of the end plate 33 is promoted, and the temperature rise of the seal member 27 is suppressed. In particular, the gaseous fuel is first guided to the radially outer side immediately after flowing out from the communication hole 34, and then its flow direction changes toward the radially inner side, causing its path to meander in the radial direction. Therefore, heat exchange with the second cylinder 32 is enhanced.

Further, a second spring 45 is provided in the expanded space S1, and the second spring 45 is cooled by the gaseous fuel whose temperature has decreased due to adiabatic expansion. As a result, it becomes possible to reduce the thermal load on the second spring 45, which is exposed to the flame in the engine combustion chamber.

Further, after the lower valve 14 is opened, the gaseous fuel guided to the radially inner side impinges on the protrusion 38 at the center of the end plate 33. As a result, the end plate 33 is cooled by the gaseous fuel that has undergone adiabatic expansion, thereby suppressing the temperature rise of the seal member 27.

According to the present embodiment described in detail above, the following advantageous effects can be obtained.

In the fuel injection valve 10, a seal member 27 is provided between the upper valve 13 and the end plate 33 to seal around the opening of the communication hole 34. As a result, compared to a configuration in which the upper valve 13 and the end plate 33 come into direct contact with each other in the closed state of the upper valve 13, it is possible to improve the gas sealing performance.

Further, when the gaseous fuel flows out from the communication hole 34 as the lower valve 14 opens, adiabatic expansion of the gaseous fuel occurs, and the end plate 33 is cooled by the gaseous fuel whose temperature has decreased due to this adiabatic expansion. As the end plate 33 is cooled, the seal member 27 provided on the opposite side of the end plate 33 from the lower valve 14 (i.e., on the side of the upper valve 13) is also cooled. In this case, although the seal member 27 is provided at a relatively close position to the lower valve 14, with only the end plate 33 interposed therebetween, excessive temperature rise of the seal member 27 is suppressed. Furthermore, since each of the upper and lower valves 13 and 14 is provided at a relatively close position with the end plate 33 interposed between the upper and lower valves 13 and 14, a decrease in responsiveness is suppressed in the passive-type lower valve 14. As a result, it is possible to protect the seal member 27 while ensuring the injection performance of the gaseous fuel.

The communication hole 34 is provided between the peripheral wall 35 and the protrusion 38 in the end plate 33 of the second cylinder 32. The opening/closing portion 42 of the lower valve 14 guides the gaseous fuel, which has flowed out from the communication hole 34 and undergone adiabatic expansion, toward both the radially outer side and the radially inner side, causing it to impact the peripheral wall 35 and the protrusion 38, respectively. In this case, the second cylinder portion 32 is cooled as the gaseous fuel, whose temperature has decreased due to adiabatic expansion, impinges on respectively the peripheral wall 35 and the protrusion 38. As a result, cooling of the end plate 33 is promoted, and the temperature rise of the seal member 27 is suppressed.

According to the configuration of the present embodiment, the desired cooling effect can be achieved by optimizing the flow direction of the cooling gas (the gaseous fuel after adiabatic expansion) using the lower valve 14. Thus, even with a simple structure, the seal member 27 can be properly cooled.

On the most upstream side of the fuel passage P2 within the nozzle body 12, the annular expanded space S1 is formed by expanding the passage dimension, and the opening/closing portion 42 of the lower valve 14 is configured to guide the gaseous fuel flowing out from the communication hole 34 toward the expanded space S1. In this case, as the gaseous fuel, which has been cooled by adiabatic expansion during the opening of the lower valve 14, is introduced into the expanded space S1, heat exchange within the expanded space S1 is enhanced. As a result, cooling of the end plate 33 is promoted, and the temperature rise of the seal member 27 is suppressed.

The cylindrical portion 41 of the lower valve 14 is provided with the opening 43 that communicates the expanded space S1 with the inner space located radially inward thereof. In this case, the gaseous fuel, which has been cooled by adiabatic expansion during the opening of the lower valve 14, flows along a path in which it is first introduced into the expanded space S1 and then proceeds into the inner space via the opening 43 of the cylindrical portion 41. As a result, the gaseous fuel can be made to meander in the radial direction within the fuel passage P2, thereby enhancing heat exchange with the second cylinder 32.

The expanded space S1 is provided with a second spring 45 that biases the lower valve 14 toward the closed position. In this case, the second spring 45 is cooled by the gaseous fuel whose temperature has decreased due to adiabatic expansion. As a result, the thermal load on the second spring 45, which is exposed to the flame in the engine combustion chamber, can be reduced.

The total volume of the multiple communication holes 34 provided in the end plate 33 of the second cylinder 32 is configured to serve as the residual gas volume that remains on the downstream side of the upper valve 13 during a period between the closing and subsequent opening of the upper valve 13. That is, the end plate 33 only needs to partition the upstream and downstream fuel passages P1 and P2, and to have a plate thickness sufficient to withstand pressure waves from the engine combustion chamber. The volume of the communication hole 34, which corresponds to this plate thickness, is the residual gas volume on the downstream side of the upper valve 13. In this case, unlike conventional structures in which a spring or the like is interposed between the upper valve 13 and the lower valve 14, it is possible to reduce the residual gas volume and thereby improve the response performance of the fuel injection valve 10.

### Other Embodiments

The above embodiment may be modified, for example, as follows.

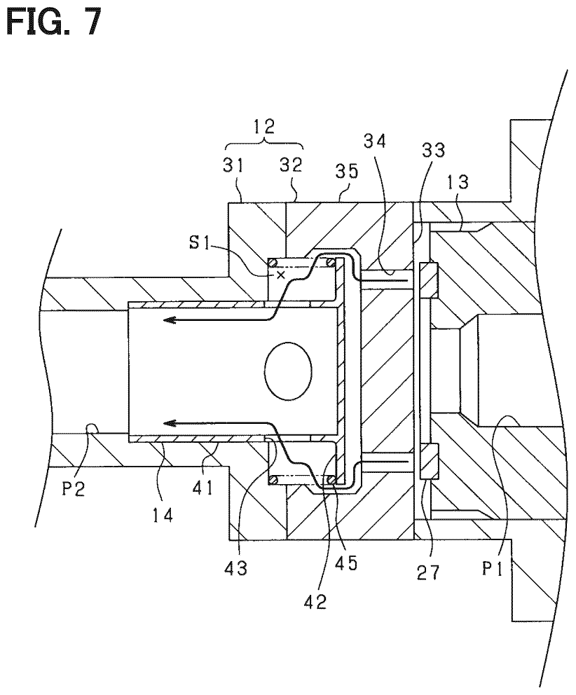

In the above embodiment, the peripheral wall 35 and the protrusion 38 of the nozzle body 12 serve as the target (extended portion) against which the gaseous fuel after adiabatic expansion collides. However, this configuration may be modified. For example, only the peripheral wall 35 may serve as the target (extended portion) against which the gaseous fuel after adiabatic expansion collides. Specifically, as shown in FIG. 7, the opening/closing portion 42 of the lower valve 14 has a disk shape with no opening in the center, and the protrusion 38 of the end plate 33 is omitted. In this case, the opening/closing portion 42 of the lower valve 14 guides the gaseous fuel, which has flowed out of the communication hole 34 and undergone adiabatic expansion, radially outward, causing the gaseous fuel to collide with the peripheral wall 35. As a result, the end plate 33 is cooled together with the peripheral wall 35, thereby suppressing the temperature rise of the seal member 27.

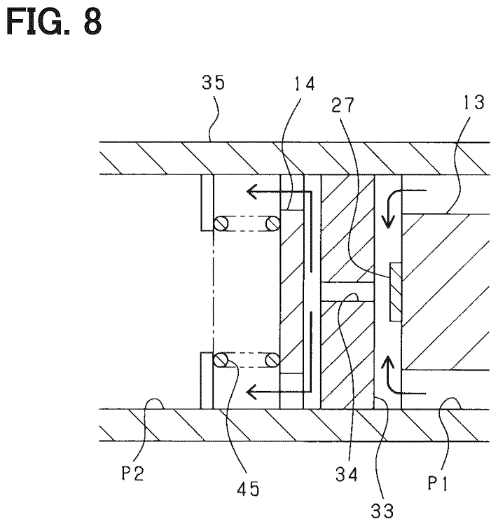

The fuel injection valve 10 may also be configured as shown in FIG. 8. It should be noted that, in FIG. 8, the main body portion is formed as a cylindrical body, and the end plate 33 (partition) is fixed at an intermediate position of the main body portion. FIG. 8 shows a state in which both the upper valve 13 and the lower valve 14 are in the open position.

In FIG. 8, a communication hole 34 is provided at the center of the disk-shaped end plate 33, and this communication hole 34 is opened and closed by the upper valve 13 from the upstream side and by the lower valve 14 from the downstream side. The lower valve 14 is biased by the second spring 45 in a direction to close the downstream opening of the communication hole 34. Also in this configuration, similarly to the above, the lower valve 14 guides the gaseous fuel, which has flowed out of the communication hole 34 and undergone adiabatic expansion, radially outward, so that the end plate 33 is cooled together with the peripheral wall 35 by the collision of the gaseous fuel with the peripheral wall 35, thereby suppressing the temperature rise of the seal member 27. It is noted that, in the lower valve 14, the surface facing the end plate 33 corresponds to the “guide portion.”

In the above embodiment, the seal member 27 is provided between the upper valve 13 and the end plate 33, and the seal member 27 is fixed to the axial end face of the upper valve 13; however, this arrangement may be modified. For example, the seal member 27 may be fixed to the side of the end plate 33.

As the drive unit for driving the upper valve 13, a configuration in which a motor is used instead of the coil 25 may be adopted.

This disclosure has been described in accordance with exemplary embodiments; however, it is understood that the present disclosure is not limited to these embodiments or structures. The present disclosure also encompasses various modifications and equivalents within the scope of the invention. Additionally, various combinations and configurations, as well as other combinations or configurations that include only one element, more than one, or less than one of those described, are also considered to fall within the spirit and scope of the present disclosure.

What is claimed is:

1. A gaseous fuel injection valve configured to directly injecting gaseous fuel into a combustion chamber of an internal combustion engine, the gaseous fuel injection valve comprising:
a main body formed in a cylindrical shape, the main body including a fuel passage and
an injection hole, the fuel passage located inside the main body, the injection hole located at a tip end of the main body, wherein
the main body includes a partition that divides the fuel passage into a first fuel passage and a second fuel passage, the first fuel passage being an upstream portion of the fuel passage, the second fuel passage being a downstream portion of the fuel passage, the partition having a communication hole through which the first fuel passage communicates with the second fuel passage,
the main body includes a first valve, a second valve, and a seal member inside the main body, the first valve configured to open and close the communication hole from a side of the first fuel passage, the second valve configured to open and close the communication hole from a side of the second fuel passage, a seal member located between the first valve and the partition, the seal member configured to seal a region around an opening of the communication hole,
the first valve is configured to be opened by a drive unit, and the second valve is configured to be opened in response to a pressure inside the communication hole exceeding a biasing force of a biasing member that is configured to urge the second valve toward a closed position,
the main body includes an extended portion that extends toward the downstream portion from the partition,
the main body includes a structure configured to cool the extended portion by causing the gaseous fuel, which has flowed out from the communication hole and undergone adiabatic expansion upon opening of the second valve, to impinge on the extended portion,
the extended portion of the main body includes:
a peripheral wall that extends toward the downstream portion from an outer periphery of the partition and forms the second fuel passage; and
a protrusion that protrudes from a position on a downstream end face of the partition toward the downstream portion, the position being located radially inward of the peripheral wall, the downstream end face facing the downstream portion,
the partition has the communication hole that is located between the peripheral wall and the protrusion, and
the second valve includes a guide portion configured to guide the gaseous fuel, which has flowed out from the communication hole and undergone the adiabatic expansion, toward a radially inner side and a radially outer side of the guide portion to impinge on the peripheral wall and the protrusion.

2. The gaseous fuel injection valve according to claim 1, wherein
the second fuel passage has a first portion at an upstream end and a second portion positioned downstream of the first portion,
a passage diameter of the first portion differs from a passage diameter of the second portion,
the first portion has an annular expanded space with a larger passage diameter than the second portion, and
the guide portion of the second valve is configured to guide the gaseous fuel, which has flowed out from the communication hole and undergone adiabatic expansion, toward a radially outer side of the guide portion and introduce the gaseous fuel into the annular expanded space.

3. The gaseous fuel injection valve according to claim 2, wherein
the second valve has a cylindrical portion that is slidable with respect to an inner peripheral surface of the main body,
the annular expanded space is located at a radially outer side of the cylindrical portion, and
the cylindrical portion has an opening through which the annular expanded space communicates with an inner space located at a radially inner side of the cylindrical portion.

4. A gaseous fuel injection valve configured to directly injecting gaseous fuel into a combustion chamber of an internal combustion engine, the gaseous fuel injection valve comprising:
a main body formed in a cylindrical shape, the main body including a fuel passage and an injection hole, the fuel passage located inside the main body, the injection hole located at a tip end of the main body, wherein
the main body includes a partition that divides the fuel passage into a first fuel passage and a second fuel passage, the first fuel passage being an upstream portion of the fuel passage, the second fuel passage being a downstream portion of the fuel passage, the partition having a communication hole through which the first fuel passage communicates with the second fuel passage,
the main body includes a first valve, a second valve, and a seal member inside the main body, the first valve configured to open and close the communication hole from a side of the first fuel passage, the second valve configured to open and close the communication hole from a side of the second fuel passage, a seal member located between the first valve and the partition, the seal member configured to seal a region around an opening of the communication hole,
the first valve is configured to be opened by a drive unit, and the second valve is configured to be opened in response to a pressure inside the communication hole exceeding a biasing force of a biasing member that is configured to urge the second valve toward a closed position,
the main body includes an extended portion that extends toward the downstream portion from the partition,
the main body includes a structure configured to cool the extended portion by causing the gaseous fuel, which has flowed out from the communication hole and undergone adiabatic expansion upon opening of the second valve, to impinge on the extended portion,
the extended portion of the main body is a peripheral wall that extends from an outer periphery of the partition toward the downstream portion and forms the second fuel passage,
the second valve includes:
a cylindrical portion that is slidable with respect to an inner peripheral surface of the main body; and
a guide portion configured to guide the gaseous fuel, which has flowed out from the communication hole and undergone adiabatic expansion, toward a radially outer side of the guide portion to impinge on the peripheral wall,
the second fuel passage has a first portion at an upstream end and a second portion positioned downstream of the first portion,
a passage diameter of the first portion differs from a passage diameter of the second portion,
the first portion has an annular expanded space with a larger passage diameter than the second portion, the annular expanded space located at a radially outer side of the cylindrical portion,
the guide portion of the second valve is configured to guide the gaseous fuel, which has flowed out from the communication hole and undergone adiabatic expansion, toward a radially outer side of the guide portion and introduce the gaseous fuel into the annular expanded space,
the cylindrical portion has an opening through which the annular expanded space communicates with an inner space located at a radially inner side of the cylindrical portion.

5. The gaseous fuel injection valve according to claim 2, further comprising:
the biasing member configured to urge the second valve toward the closed position, the biasing member located at the annular expanded space.

6. A gaseous fuel injection valve configured to directly injecting gaseous fuel into a combustion chamber of an internal combustion engine, the gaseous fuel injection valve comprising:
a main body formed in a cylindrical shape, the main body including a fuel passage and an injection hole, the fuel passage located inside the main body, the injection hole located at a tip end of the main body, wherein
the main body includes a partition that divides the fuel passage into a first fuel passage and a second fuel passage, the first fuel passage being an upstream portion of the fuel passage, the second fuel passage being a downstream portion of the fuel passage, the partition having a communication hole through which the first fuel passage communicates with the second fuel passage,
the main body includes a first valve, a second valve, and a seal member inside the main body, the first valve configured to open and close the communication hole from a side of the first fuel passage, the second valve configured to open and close the communication hole from a side of the second fuel passage, a seal member located between the first valve and the partition, the seal member configured to seal a region around an opening of the communication hole,
the first valve is configured to be opened by a drive unit, and the second valve is configured to be opened in response to a pressure inside the communication hole exceeding a biasing force of a biasing member that is configured to urge the second valve toward a closed position,
the main body includes an extended portion that extends toward the downstream portion from the partition,
the main body includes a structure configured to cool the extended portion by causing the gaseous fuel, which has flowed out from the communication hole and undergone adiabatic expansion upon opening of the second valve, to impinge on the extended portion,
the communication hole is configured to accommodate residual gas that remains downstream of the first vale during an interval between closure of the first valve and subsequent opening of the first valve such that a total volume of the communication hole matches a volume of the residual gas.
